(19) United States
(12) Patent Application Publication
(10) Pub. No.: US 2024/0243503 A1
(43) Pub. Date: Jul. 18, 2024

(54) VIBRATION-RESISTANT ELECTRICAL FLAT FEMALE TERMINAL

(71) Applicant: TE Connectivity Solutions GmbH, Schaffhausen (CH)

(72) Inventors: Kevin SCHEER, Bensheim (DE); Harald ULRICH, Bensheim (DE); Stefan MASAK, Bensheim (DE)

(21) Appl. No.: 18/412,960

(22) Filed: Jan. 15, 2024

(30) Foreign Application Priority Data
Jan. 18, 2023 (DE) 102023101116.2

(51) Int. Cl. H01R 13/11; H01R 13/533

(52) U.S. Cl. CPC H01R 13/11; H01R 13/533; H01R 2201/26

(57) ABSTRACT

The invention relates to a vibration-resistant electromechanical flat socket terminal, such as a high-voltage flat socket terminal, for an electrical connection, such as a high-voltage connection for a vehicle, such as a vehicle with an electric traction motor, with an essentially cuboid tab contact receptacle into which an essentially cuboid tab contact section of an electrical mating terminal, such as a high-voltage mating terminal, for making electrical contact with the flat socket terminal can be plugged, wherein the tab contact receptacle is formed between a plug contact section of an electromechanical connection piece and a mechanical contact spring cage, formed apart therefrom, of the flat socket terminal.

### CROSS REFERENCE TO RELATED APPLICATIONS

This application claims the benefit of DE application Ser. No. 10/202,3101116.2 filed 18 Jan. 2023, the subject matter of which is herein incorporated by reference in its entirety.

### BACKGROUND OF THE INVENTION

The subject matter herein relates to high-voltage terminals for an electrical connection.

In the electrical area (electrics, electrical technology, electrical engineering, etc.), apart from ground-based electrical engineering and analogues thereof, a large number of electrical connectors are known. They are used to transmit electrical voltages, for example in the high-voltage range (high voltages: alternating voltages over 24V and up to over 1 kV, direct voltages over 48V and up to over 1.5 kV) and/or electric currents in the high-current range (high currents over 25 A and up to over 1 kA). The connectors must here ensure faultless transmission for the supply and/or distribution of electrical energy in warm, possibly hot, dirty, damp and/or chemically aggressive environments in the short term and/or permanently. This of course also applies for a low-voltage and/or weak-current range.

Because of a wide range of applications, a large number of such connectors are known in the automotive sector and nonautomotive sector apart from ground-based electrical engineering and analogues thereof. In the automotive sector, such a high-voltage and/or high-current connector is suitable, for example, for connecting electrical high-voltage and/or high-current lines, electrically connecting such a line to a corresponding electrical high-voltage entity, and vice versa, or for another type of electromechanical contacting. In this specification, it is intended that the term high-voltage also includes the term high-current.

The high-voltage connector can be used for a direct or an indirect high-voltage and/or high-current connection for an electrical high-voltage and/or high-current source. Such a high voltage and/or such a high current comes from an electrical high-voltage entity or is determined for a high-voltage entity. Such a high-voltage entity is, for example, a rechargeable battery module or a rechargeable battery, a traction battery module or a traction battery, an inverter, switchgear, an electric (traction) motor, an apparatus, an appliance, etc. (cf also below).

High costs for fossil fuels and efforts to reduce environmental impacts make necessary, for example, hybrid or electric vehicles in the automotive sector. One aspect of these vehicles is the handling of high electrical charging and operating voltages and high electrical charging and operating currents, wherein relevant components of the vehicles have to be designed accordingly. This is relevant, for example, for high-voltage lines (for example, stranded lines, busbars, etc. made from a copper alloy or preferably an aluminum alloy) and for the relevant high-voltage terminals (for example, connection pieces, flat contacts, busbars, etc. made from an aluminum alloy or preferably a copper alloy) of the high-voltage connectors.

Such a high-voltage connector and its housing can be provided at an electrical line, a cable, a cable harness, etc., referred to below as a (pre)assembled (electrical) cable, this also being referred to here as an electrical high-voltage entity. A high-voltage connector and its housing can moreover be provided at/in an electrical device or means such as, for example, at/in a housing, at/on a leadframe, at/on a busbar etc.; a (power) electrical component or a corresponding aggregation etc., this likewise also being referred to here as an electrical high-voltage entity.

If a connector is situated at a cable, this is also described as a flying (plug) connector or a plug, a socket or a coupling; if it is situated at/in an electrical component, aggregation, etc., this is also described as a connector device such as, for example, a (built-in/attached) connector, a (built-in/attached) plug or a (built-in/attached) socket. In electrical engineering (generating, converting, storing and transporting electrical heavy current in electrical networks preferably with three-phase current high-voltage transmission), they are described as cable fittings because of their complex construction.

There are constant ongoing efforts to improve electrical connectors and their terminals, in particular to design them more effectively and to configure and/or produce them more cost-effectively. Failure to comply with vibration requirements (LV 214 or LV 215 of class or severity level 2, 3 and/or 4, or an analogue) for electrical high-voltage connections is often due to relative movements between plugged-together socket and tab terminals caused by the high masses involved and by the vibrational loads because of the relatively heavy terminals and lines for high-voltage connections.

It is hard to meet the LV 214 or LV 215 vibration requirements at severity level 3 or above using conventional flat socket terminals or high-voltage flat socket terminals. In order to be able to produce the retaining forces required therefor, additional measures are necessary, which results in cost-intensive solutions such as, for example, cost-intensive flat socket terminals or T-type flat socket terminals and takes up additional structural space.

There is a need for a vibration-resistant electrical connection for a vehicle.

### BRIEF DESCRIPTION OF THE INVENTION

In one embodiment, the subject matter herein provides a vibration-resistant electrical connection by means of a vibration-resistant electromechanical flat socket terminal is provided, including a T-type flat socket terminal, for an electrical connection, including a T-type connection; by means of a vibration-resistant electrical connector, including a T-type connector; by means of a vibration-resistant electrical connection, including a T-type connection; and by means of an electrical entity, including a T-type entity preferably in each case for a vehicle, such as a vehicle with an electric traction motor. Advantageous developments, additional features and/or advantages of the subject matter herein can be found in the dependent claims and the following description.

In various embodiments, a flat socket terminal is provided including an essentially cuboid tab contact receptacle into which an essentially cuboid tab contact section of a mating terminal, in particular a T-type mating terminal, can be plugged in order to make electrical contact with the flat socket terminal, wherein the tab contact receptacle is formed between a plug contact section of an electromechanical connection piece and a mechanical contact spring cage, formed apart therefrom, of the flat socket terminal. The connection piece may be produced from copper or a copper alloy and the contact spring cage preferably from a steel, in particular a spring steel. Other materials such as, for example, aluminum or an aluminum alloy can of course be used for the connection piece.

The single flat socket terminal can be formed as a terminal which is rigidly mechanically connected in at least or exactly two parts from the plug contact section and the contact spring cage. The contact spring cage can here be formed a single part (cf below: as a materially bonded single piece or integrally) or as multiple parts. The contact spring cage can be built on the plug contact section with a substantially flat form, and an upper inner side of the contact spring cage and an outer side of the plug contact section can delimit the tab contact receptacle. At least one further lateral inner side, in particular two further lateral inner sides of the contact spring cage, can moreover delimit the tab contact receptacle.

The plug contact section of the connection piece can be formed essentially or substantially as a tab. This means that a tab-to-tab plug connection (first tab: plug contact section, second tab: tab contact section of the mating terminal) can be effected by means of the contact spring cage of the flat socket terminal. At least the plug contact section can be formed as a materially bonded single piece or integrally. The details given below of the formation of the contact spring cage as a materially bonded single piece and/or integrally can of course be applied here analogously to the plug contact section, the whole connection piece or wherever appropriate. The plug contact section at/in the tab contact receptacle can have a plurality of electromechanical contacting regions (domes) which are formed, for example, as (solid) projections or beads. Other types of contacting regions such as, for example, contact springs can of course be used.

The contact spring cage can be accessible for the tab contact section at at least or exactly one side. This means that it is envisaged that the tab contact section can be plugged into the tab contact receptacle from a single side or from (at least) two sides. The contact spring cage can moreover be formed as a single piece, as a materially bonded single piece or integrally. It is of course possible to form the contact spring cage as multiple pieces, in particular two pieces.

A single-piece form is understood to mean a form of the contact spring cage in which its constituent parts are fixed to each other in a force and/or formfitting fashion and the contact spring cage can preferably be separated into its constituent parts again without causing damage, optionally with the use of a tool. The contact spring cage is designed as a multipart but single piece.

A materially (adhesively) bonded single-piece form is understood to mean a form of the contact spring cage in which its individual parts are fixed to each other in a materially bonded fashion (welding, soldering, adhesive bonding, etc.) and the contact spring cage can preferably not be separated into individual parts without damaging one of its individual parts. The contact spring cage can here moreover be held together by means of a force and/or form fit (not in the case of an integral form).

An integral form is understood to mean a form of the contact spring cage in which there is just a single part which can be separated only by it being destroyed. The part is manufactured from a single original piece (sheet metal, blank, etc.) and a single original mass (molten metal) which for its part is necessarily integral. It is held together internally by means of adhesion and/or cohesion. A materially (adhesively) bonded single-piece lamination, coating, etc. or an integral deposition, galvanization, etc. can additionally be present here.

The contact spring cage can furthermore be formed as a bent spring and/or a stamped spring. The contact spring cage can here be formed in particular as a spring bent by 180° or in particular as a shaped stamped spring. The bent spring can of course have been formed as a stamped or shaped and stamped spring before being bent.

The contact spring cage can be formed as substantially closed at at least three, at least four or at five sides. A contact spring cage formed as substantially closed on three sides preferably comprises two side walls and a cover wall. A contact spring cage substantially closed on four sides additionally comprises a bottom wall and, in the case of a contact spring cage substantially closed on five sides, an end side is additionally at least partly closed in such a way that the tab contact section of the mating terminal cannot be plugged through this side.

A cover wall of the contact spring cage can have at least one mechanical cover contact spring protruding or projecting into the tab contact receptacle. At least one side wall of the contact spring cage can moreover have a mechanical side contact spring protruding or projecting into the tab contact receptacle. The at least one cover contact spring and/or the at least one side contact spring can be formed as a contact spring bent by approximately 180° into the tab contact receptacle. A 0° attachment of the cover contact spring and/or the side contact spring can of course also be used.

The relevant contact spring serves to mechanically receive or mount the tab contact section of the mating terminal in the tab contact receptacle in a fixedly spring-loaded fashion, i.e. so that it can move only to a limited extent. The at least one cover contact spring serves in particular to push/press the tab contact section preferably onto the contacting regions of the plug contact section. And the at least one side contact spring serves in particular to meet the vibration requirements for the flat socket terminal.

The at least one cover contact spring and the at least one side contact spring here interact of course via the tab contact section of the mating terminal such that in particular the cover contact spring can also contribute to meeting the vibration requirements. The relevant contact spring can be attached to one side or both sides of a receptacle body of the contact spring cage and forms, in addition to its deformability in particular as a spring, a pivotable and/or linearly movable inner delimitation of the tab contact receptacle.

The contact spring cage can be formed in such a way that the contact springs center the tab contact section plugged into the tab contact receptacle there and push it there against the plug contact section. The contact spring cage can moreover be formed in such a way that a spring direction of the at least one cover contact spring and a spring direction of the at least one side contact spring are substantially perpendicular to each other. For this purpose, a cover contact spring is configured so that it can move in both vertical directions and a side contact spring in both transverse directions at/in the contact spring cage or at/in the tab contact receptacle.

The contact spring cage can furthermore be formed in such a way that the at least one cover contact spring and the at least one side contact spring extend substantially in the longitudinal direction of the flat socket terminal. Furthermore, a cover contact spring and/or a side contact spring can have exactly or at least one mechanical contact projection for making electromechanical contact with the tab contact section. Thus, for example, two, three or more contact projections per contact spring can be configured, wherein a relevant number of contact projections of the contact springs of course does not need to be the same.

The at least one cover contact spring can be configured at/in the tab contact receptacle so that it is spring-loaded in the vertical direction of the flat socket terminal above the plug contact section. The at least one side contact spring can moreover be configured at/in the tab contact receptacle so that it is spring-loaded in the transverse direction of the flat socket terminal above the plug contact section. Furthermore, two side contact springs situated opposite each other in the transverse direction can be configured at/in the tab contact receptacle so that they are spring-loaded against each other.

A single contact spring can be attached integrally (analogously to above) on one or both sides of the receptacle body of the contact spring cage in the longitudinal direction. If the relevant contact spring is attached on one side, it is preferred if there is an approximately 180° attachment of the contact spring to the receptacle body. For example, for this purpose the contact spring has been bent from outside into a receptacle body which is here preferably still open. If the relevant contact spring is attached on two sides, it is preferred if there is an approximately 0° attachment of the contact spring to the receptacle body. For example, for this purpose the contact spring is cut out from a wall of the receptacle body, which can be effected in particular by a stamping process.

A single contact spring can have in its longitudinal central region at least or exactly one mechanical contact projection protruding into the tab contact receptacle. A single contact spring can moreover have, apart from its contact projection, a front spring section and possibly a rear spring section. A spring section here extends of course in one longitudinal direction away from the contact projection, whereas the other spring section extends away from the contact projection in the other longitudinal direction. The front spring section, the contact projection and the rear spring section preferably have a V-shape. A free end section of a single contact spring can be mounted so that it can slide on an inner side of the receptacle body (of course only in the case of a one-sided attachment of the contact spring). The free end section here preferably has a V-shape.

The contact spring cage can have a bottom wall via which the contact spring cage is fixed to the plug contact section. This means that the contact spring cage is preferably formed as substantially closed on at least four sides (two side walls, cover wall, bottom wall). The two side walls can in each case have a through opening through which the plug contact section is plugged into the contact spring cage. A through opening, on the inside of the socket terminal, of the side wall is in particular formed so that it is larger than a through opening, on the outside of the socket terminal, of the side wall situated opposite in the transverse direction. The through openings are here of course preferably configured “concentrically” in the contact spring cage.

The through opening on the inside of the socket terminal can be dimensioned in such a way that substantially the whole plug contact section can be plugged through in the transverse direction. The through opening on the inside of the socket terminal can be dimensioned in such a way that at least one blocking shoulder of the connection piece sits on the outside of the receptacle body. The through opening on the outside of the socket terminal can be dimensioned in such a way that at least one blocking shoulder of the plug contact section sits on the inside of the receptacle body. Two blocking shoulders per through opening are preferably used which are configured one behind the other in the longitudinal direction on the connection piece or on the plug contact section.

The plug contact section can be fixed in the receptacle body of the contact spring cage on the bottom wall by means of mounting means. A mounting means can be formed as a mounting tab of the bottom wall which is exposed from the bottom wall. The mounting tab can engage around an (outer) edge of the plug contact section and in this way fix the receptacle body on the plug contact section. A free end section of the mounting tab can be bent at/in the tab contact receptacle into a depression of the plug contact section.

A plurality of such mounting tabs are of course preferably formed at the bottom wall. In particular, at least or exactly two mounting means of the bottom wall per transverse side of the plug contact section fix the receptacle body or the contact spring cage on the plug contact section. It is here moreover preferred that the mounting means have a large or as large as possible spacing from one another.

The flat socket terminal as a T-type flat socket terminal can be designed for electrical voltages of at least approximately: 100V, 200V, 300V, 400V, 500V, 600V, 750V, 1 kV, 1.25 kV, 1.5 kV, 1.75 kV or 2 kV. The T-type flat socket terminal can here moreover be designed in such a way that it can in each case withstand short-term electrical voltages which are considerably above these values (for example, dynamic drive mode by approximately: +175%, +200%, +250%, +300%, +350%, +400%, +500%). The T-type flat socket terminal can be designed for permanent electrical currents of at least approximately: 100 A, 200 A, 300 A, 400 A, 500 A, 750 A, 1 kA or 1.25 kA. The T-type flat socket terminal can here moreover be designed in such a way that it can in each case withstand short-term electrical currents which are considerably above these values (for example, dynamic drive mode by approximately: +175%, +200%, +250%, +300%, +350%, +400%, +500%).

The flat socket terminal can, for example in accordance with LV 214, LV 215 or an analogue, meet the vibration requirements of the class or at severity level 2, 3 and/or 4. In particular, the vibration requirement of the class or at severity level 3 is met by means of the flat socket terminal. It may moreover be possible that the flat socket terminal does not, for example in accordance with LV 214, LV 215 or an analogue, meet the vibration requirements of the class or at severity level 4 and/or higher. The flat socket terminal is preferably designed for a usage temperature of approximately 40° C. to approximately: 80° C., 100°, 120° C., 140° C., 150° C., 160° C., 170° C. or 180° C. The specifications regarding the voltage rating, current-carrying capacity, vibration resistance and/or temperature resistance can of course also apply for the tab terminal, a connector (cf below) and/or a connection (cf below).

In various embodiments, it is possible to use an integral contact spring cage made from a stainless steel which has better material properties in order to meet the vibration requirements than copper and is much more cost-effective than the latter. This contact spring cage formed, for example, as a 180° bent spring enables in each case multiple embodiments for the required force ranges in order to meet the vibration requirements. The flat socket terminal with its contact springs made from steel has a much lower plugging force than flat socket terminals with copper springs. A vibration strength (side contact springs) of the flat socket terminal can be set independently of a mechanical normal force (cover contact spring or springs).

In various embodiments, a connector includes a connector housing and an electromechanical flat socket terminal configured thereon/therein. The connection includes an electromechanical flat socket terminal and an electrical mating terminal, in particular a T-type mating terminal, having a tab contact section, wherein the tab contact section is formed so that it partially complements the tab contact receptacle of the flat socket terminal.

The tab contact section can have at least one partially complementary clamping means corresponding to the contact spring cage. The tab contact section preferably has exactly or at least two clamping means which are preferably configured at sides at/in the tab contact section which are situated opposite each other. Two or more clamping means per side can of course also be used. The clamping means can be configured as a clamping recess in a large-area and/or narrow side of the tab contact section. A mechanical contact region of a contact spring of the contact spring cage can, for example, be seated in the clamping means.

At least one blocking projection of the tab contact section can moreover sit on an outer edge of an opening of the tab contact receptacle. At least two blocking projections, configured on sides of tab contact section which are situated opposite each other, preferably sit on a peripheral outer edge of the opening of the tab contact receptacle. In each case at least one, in particular in each case two such blocking projections are configured here in particular on the large-area sides of the tab contact section. A blocking projection can be configured, for example, as a bead in the tab contact section.

A position of the at least one blocking projection at/on the tab contact section can here be chosen in such a way that it applies a mechanical tensile force to a bracket of the tab contact section by means of, for example, two mechanical contact springs, for example the side contact springs (cf above the clamping means and below), in the flat socket terminal. As a result, the tab contact section can be held substantially with no play in the tab contact receptacle in the plugin direction and the unplugging direction of the tab contact section in the flat socket terminal.

A mechanical contact region of a contact spring and a relevant clamping means of the tab contact section can be mutually designed in such a way that, in case of vibrations on the connection, the tab contact section has the tendency to move further into the tab contact receptacle. This can be reversed, for example, as follows.

In the case of inwardly directed contact projections of two mechanical contact springs which are, for example, configured in the tab contact section so that they are mirror-symmetrical with respect to the longitudinal direction of the tab contact section (i.e. the tab contact section can be projected on itself there) such as, for example, the side contact springs; a front edge (closer to a free plugin end of the tab contact section) of a respective relevant clamping recess of the tab contact section can be configured as steeper in the tab contact section than a rear edge (further away from this free plugin end) of the respective relevant clamping recess in the tab contact section. In a plan view of such a clamping recess, the latter has, for example, approximately a V-shape with a short front and a longer rear leg.

In various embodiments, an entity is provided including an electrical device and a flat socket terminal, a connector and/or a connection. Such an entity can be formed, for example, as an electrical device, a (pre)assembled electrical cable, an electrical subassembly, an electrical busbar, an electrical module (for example a rechargeable battery module, traction battery module), \an electrical component (for example, a rechargeable battery, traction battery, inverter), an electrical appliance, an electrical apparatus, switchgear, an electric (traction) motor, an electrical unit, an electrical installation, an electrical system, etc.

A vehicle in particular a motor vehicle (road vehicle) but also a rail vehicle, a water vehicle and/or an aircraft with an electric traction motor is understood to mean a motor vehicle which, in addition to an electric traction motor, can have a further nonelectric drive such as, for example, an internal combustion engine. This means that a vehicle with an electric traction motor can be understood to mean, for example, a hybrid electric vehicle, an electric vehicle (only an electromotive drive), a fuel cell vehicle, etc.

The invention is explained in detail below on the basis of exemplary embodiments with reference to the attached schematic drawings which are not to scale. Sections, elements, parts, units, components and/or diagrams which have an identical, unequivocal or analogous form and/or function are designated by the same reference signs in the description of the drawings (see below), the list of reference signs, the claims and in the Figures in the drawings. A possible alternative which is not explained in the description of the invention (see above), is not illustrated in the drawings and/or is non-exhaustive, a static and/or kinematic reversal, a combination, etc. of the exemplary embodiments of the invention or of a component, a diagram, a unit, a part, an element or a section thereof, can moreover be found in the list of reference signs and/or the description of the drawings.

In the invention, a feature (section, element, part, unit, component, function, size, etc.) can take a positive form, i.e. be present, or take a negative form, i.e. be absent. In this specification (description (description of the invention (see above), description of the drawings (see below)), list of reference signs, claims, drawings), a negative feature is not explicitly explained as a feature when according to the invention no importance is placed on whether it is absent. This means that the actual invention, and not an invention constructed according to the prior art, consists in omitting this feature.

A feature of this specification can be applied not only in a stated manner but also in a different manner (isolated, combined, replaced, added, made standalone, omitted, etc.). In particular, it is possible to replace, add or omit a feature in the claims and/or the description with the aid of a reference sign and a feature assigned thereto, and vice versa, in the description, the list of reference signs, the claims and/or the drawings. Furthermore, a feature can consequently be explained and/or specified in detail in a claim.

The features of the description can (given the (initially mostly unknown) prior art) also be interpreted as optional features; i.e. each feature can be considered as an optional, arbitrary or preferred, i.e. nonbinding, feature. It is thus possible to extract a feature, possibly including its periphery, from an exemplary embodiment, wherein this feature can then be transferred to a generalized inventive concept. The lack of a feature (negative feature) in an exemplary embodiment shows that the feature may be optional (known to a person skilled in the art) with regard to the invention. Moreover, a term of art for a feature can also be interpreted as a generic term for the feature (possible further hierarchical subdivision into subgenus, etc.), as a result of which it is possible to generalize the feature considering its same effect and/or equivalence.

### BRIEF DESCRIPTION OF THE DRAWINGS

FIG. 1 shows a two-dimensional end view in a longitudinal direction of an embodiment of a vibration-resistant electromechanical flat socket terminal in accordance with an exemplary embodiment for a vehicle,

FIGS. 2 and 3 show in a perspective view with the top removed (FIG. 2) and in a two-dimensional side view in section (FIG. 3) a tab contact receptacle of the flat socket terminal from FIG. 1, and

FIGS. 4 and 5 show in two-dimensional plan views with the top removed the tab contact receptacle of the flat socket terminal from FIG. 1 during the plugging in of a tab contact section of a mating terminal.

### DETAILED DESCRIPTION OF THE INVENTION

The subject matter herein is explained in detail below on the basis of exemplary embodiments of a vibration-resistant electromechanical high-voltage flat socket terminal 1 (10, 20) (which can also be referred to as a high-current flat socket terminal 1) for a high-voltage connection 0 (which can also be referred to as a high-current connection 0). The subject matter herein can of course also be applied to flat socket terminals 1 for vibration-resistant electrical connections 0 in the low-voltage and/or weak-current range.

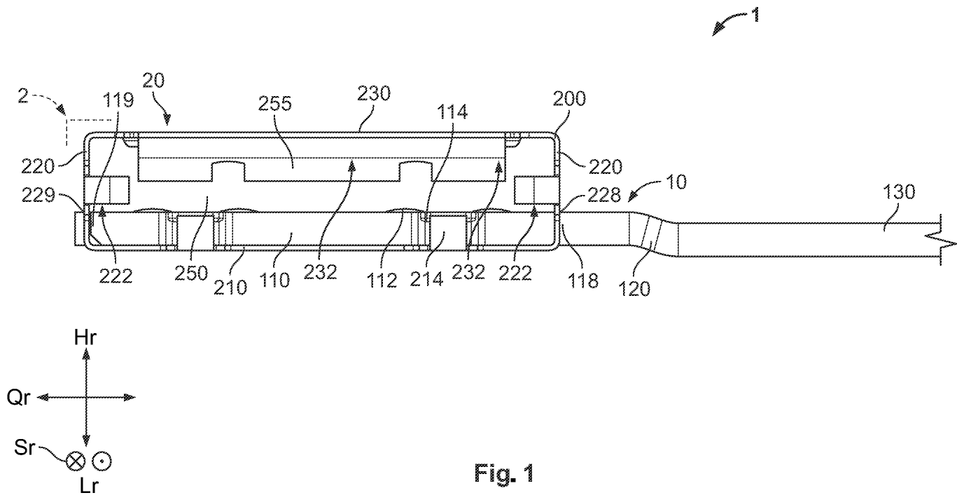

The high-voltage flat socket terminal 1 can here of course be installed in a connector housing 2 (cf FIG. 1) to form a vibration-resistant electrical high-voltage connector 1, 2. The high-voltage connector 1, 2 can be formed, for example, as a plug connector 1, 2, an attached connector 1, 2, a built-in connector 1, 2, etc. A high-voltage connection 0 comprises a high-voltage flat socket terminal 1 or a high-voltage connector with a high-voltage flat socket terminal 1, and an electrical high-voltage mating terminal 5 or an electrical high-voltage mating connector with a high-voltage mating terminal 5. The same applies of course for the vibration-resistant electrical connector 1, 2 and the connection 0 in the low-voltage and/or weak-current range.

Although the invention is described and illustrated in more detail by preferred exemplary embodiments, the invention is not limited by the disclosed exemplary embodiments and instead is of a more fundamental nature. Other variants can be derived therefrom and/or from the above (description of the invention) without going beyond the scope of protection of the invention. The invention can generally be applied in the electrical sector, i.e. also in the nonautomotive sector, in the case of an electrical entity (cf above). Ground-based electrical engineering and analogues thereof form an exception. Only those physical portions of a subject of the invention are illustrated in the drawings which are necessary for understanding the invention. Terms such as connector and mating connector, terminal and mating terminal, etc. are to be interpreted synonymously, i.e. may in each case be interchangeable.

The explanation of the invention (cf also above) on the basis of the drawings is made below with reference to a longitudinal direction Lr, a vertical direction Hr and a transverse direction Qr of the connection 0, of the flat socket terminal 1, etc. The longitudinal direction Lr (an example thereof is a plugin direction Sr of a tab contact section 550 of a mating terminal 5, cf below) here corresponds to a main direction of extent of a tab contact receptacle 250 and the main directions of extent of the contact springs 222, 232, situated in/at the latter, of the flat socket terminal 1. Moreover, an electromechanical connection piece 10 extends with its plug contact section 110 substantially in the transverse direction Qr; alternatively, the plug contact section 110 can also be configured on the connection piece 10 so that it is angled. An electrical contact surface of the plug contact section 110 extends in the longitudinal direction Lr and transverse direction Qr, and a thickness of the plug contact section 110 and the tab contact section 550 extend in the vertical direction Hr.

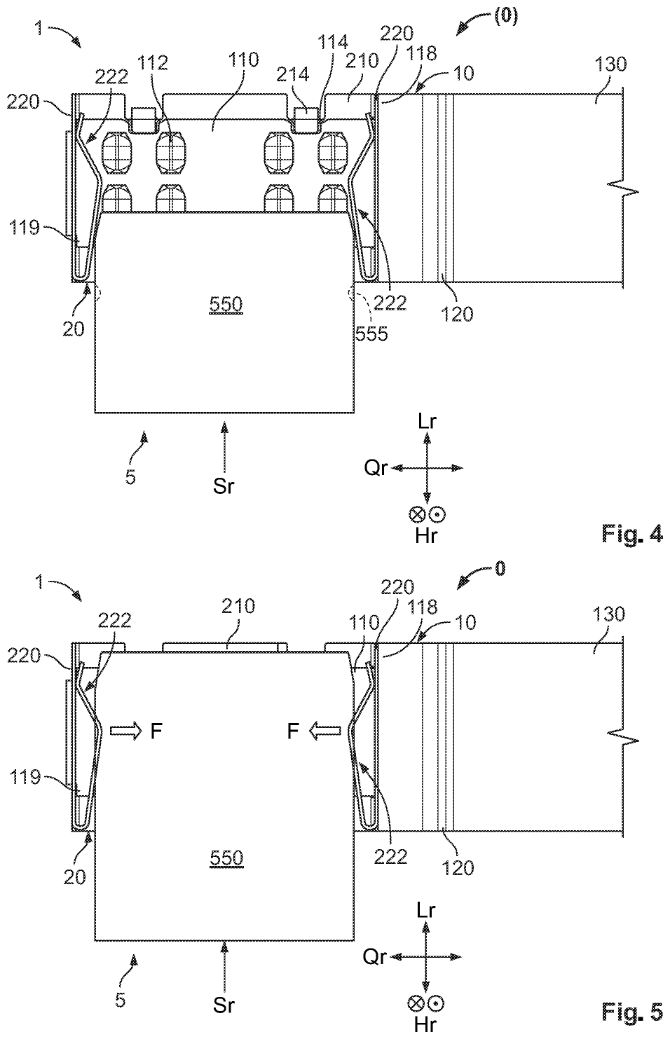

Firstly, compare FIGS. 4 and 5; in the present case, the mating terminal 5 has a tab contact section 500 which can be plugged into a tab contact receptacle 250 of the flat socket terminal 1. Apart from the tab contact section 550, the mating terminal 5 can be formed for specific applications. The tab contact section can have a touch protection means at its free end; clamping means 555, in particular clamping recesses 555, for example for contact springs 222, 232 of the tab contact section 500, at sides situated opposite each other; and blocking projections (for example, beads as stops in the plugin direction Sr) etc. at sides situated opposite each other (cf above).

FIG. 1 shows a mating terminal 1 for the mating terminal 5 as a flat socket terminal 1 comprising an integral electromechanical connection piece 10 and an integral mechanical contact spring cage 20. The connection piece 10 and/or the contact spring cage 20 can of course also be formed as multiple parts, a single piece or materially bonded as a single piece (cf above).

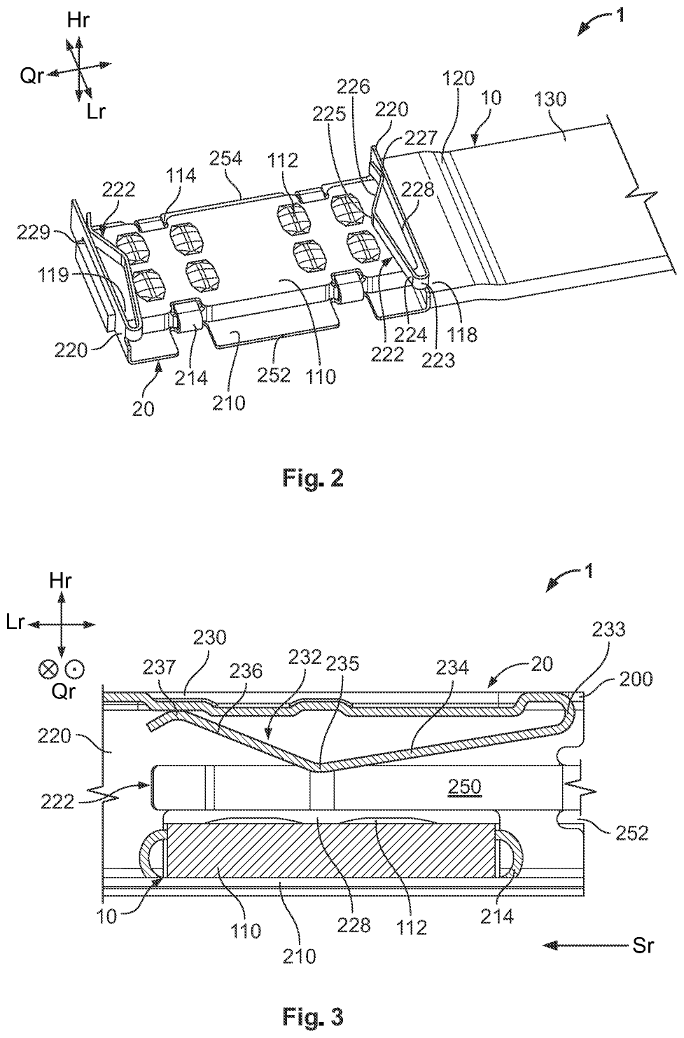

The electromechanical connection piece 10, cf also FIG. 2, comprises a plug contact section 110 and, for example, adjoining the latter, a transition section 120 and, for example, adjoining the latter, a connection section 130. The connection section 130 is formed, for example, as a fixed contact section 130 with a welding region, a weld pad, etc. A different form of the connection section 130, for example in the form of a welding compacting section, a crimping section, etc. can of course be used. The transition section 120 can be used as thickness compensation of a bottom wall 210 (cf below) of the contact spring cage 20 (cf FIG. 1).

In the present case, the plug contact section 110 is formed essentially or substantially with a tab shape, wherein the contact spring cage 20 is fixed on the plug contact section 110 and fixed above the latter with its tab contact receptacle 250 or contact chamber 250. An inner, substantially free surface of the plug contact section 110 and the inner sides, built on the latter, of the contact spring cage 20 here define substantially the socket-shaped tab contact receptacle 250 or the contact chamber 250 of the flat socket terminal 1, into which the tab contact section 550 of the mating terminal 5 can be plugged.

The plug contact section 110 has a plurality of electromechanical contacting regions 112 on its inner free surface in/at the tab contact receptacle 250. The contacting regions 112 serve to electrically connect the plug contact section 110 to the tab contact section 550 by being seated or pressed thereon. In the present case, two sets of four contacting regions 112 are configured. Moreover, the plug contact section 110 has depressions 114 in its inner free surface in which free end sections of mounting tabs 214 (cf below) of the contact spring cage 20 can be received so that they do not protrude substantially from a surface of the plug contact section 110.

For mounting the contact spring cage 20 at/on the connection piece 10 by being plugged, the connection piece 10 has at least one blocking shoulder 118 (as a barrier between the actual connection piece 10 and the actual plug contact section 110) and the plug contact section 110 of the connection piece 10 has at least one blocking shoulder 119. In each case two blocking shoulders 118, 118; 119, 119 are preferably configured one behind the other in the longitudinal direction Lr on the connection piece 10 or plug contact section 110. The respective blocking shoulder 118, 119 here enlarges a cross-section of the connection piece 10 or the plug contact section 110 in such a way that the connection piece 10 or the plug contact section 110 can no longer be plugged again through a through opening 228, 229 (cf below) in a relevant side wall 220 of the contact spring cage 20. The respective blocking shoulder 118, 119 can of course also be formed as a section of a locking collar.

The mechanical contact spring cage 20, cf FIGS. 1 to 3, has in the present case a receptacle body 200 with a substantially flat rectangular cross-section (transverse direction Qr, vertical direction Hr). The receptacle body 200 is here formed as essentially or substantially closed on at least four sides and comprises a bottom wall 210, a (first) side wall 220, a cover wall 230 and a (second) side wall 220, wherein the walls 210, 220, 230, 220 merge integrally into one another in this sequence in a peripheral direction. Apart from the plug contact section 110, these walls 210, 220, 230, 220 form the tab contact receptacle 250 of the contact spring cage 20 on the inner surface of the plug contact section 110.

A front-end side 252 of the contact spring cage 20 is formed as open for the access of the tab contact section 550 into the tab contact receptacle 250. The rear end side 254, situated opposite this one in the longitudinal direction Lr, of the contact spring cage 20 can likewise be formed as open. This end side 254 is, however, preferably formed as at least partially closed. In the present case, a stop means 255 formed in particular as a wide stop tab 255 is provided at the front side 254 and extends, starting from the cover wall 230, in the vertical direction Hr in the direction of the bottom wall 210.

The side walls 220, 230 have through openings 228, 229 through which the plug contact section 110 is plugged at least partially, or vice versa, for mounting the contact spring cage 20 on the plug contact section 110. The plug contact section 110 can in this way be plugged into the contact spring cage 20 until its blocking shoulders 118, 119 come to sit against the contact spring cage 20. At least one blocking shoulder 118 of the connection piece 10 here comes to bear against an outer edge of a through opening 228, on the inside of the socket terminal, of one side wall 220, and one blocking shoulder 119 of the plug contact section 110 against an inner edge of a through opening 229, on the outside of the socket terminal, of the other side wall 220.

The plug contact section 110 is here arranged on the bottom wall 210. After the plug contact section 110 has been mounted via the through openings 228, 229, the mounting tabs 214 which are exposed from the bottom wall 210 are bent around the transverse edges, situated opposite each other in the longitudinal direction Lr, of the plug contact section 110. The free end sections of the mounting tabs 214 are here received in the depressions 114 of the plug contact section 110. A different fastening of the contact spring cage 20 above the plug contact section 110 can of course be used. At least one contacting region 112 of the plug contact section 110 is preferably configured substantially directly adjacent to a mounting tab 214 which engages around the relevant transverse edge.

Each side wall 220 has at least one mechanical side contact spring 222 attached in the longitudinal direction Lr to one side (as in the present case) or both sides of the receptacle body 200. A relevant attachment 223 to the receptacle body 200 is here an integral one. If the side contact spring 222 is attached on one side as illustrated, the attachment 223 is preferably an approximately 180° attachment 223, and in the case of an approximately 0° attachment 223, the side contact spring 222 is exposed from the side wall 220, for example in the manner of a strip.

A side contact spring 222 illustrated (cf in particular FIG. 2) merges integrally into its side wall 220 via an approximately 180° attachment 223. Starting from the approximately 180° attachment 223, the side contact spring 222 comprises a (front) spring section 224 which protrudes into the tab contact receptacle 250 and ends in a mechanical contact projection 225 protruding furthest from the side contact spring 222 into the tab contact receptacle 250.

Starting from the contact projection 225, the side contact spring 222 retreats again in the direction of its side wall 220 via a (rear) spring section 226 and ends there in a free end section 227. The free end section 227 comprises, situated opposite the inner side of the side wall 220, a curvature and bears with the latter in sliding fashion against the side wall 220. In the case of a side contact spring 222 attached on both sides, it here merges of course into the side wall 220.

In particular, the respective side wall 220 has a single side contact spring 222 such that two side contact springs 222 with contact projections 225 which run toward each other are configured in the tab contact receptacle 250 (cf FIGS. 2 and 4). When a tab contact section 550 is plugged into the tab contact receptacle 250 (FIG. 4), the contact projections 225 are pushed apart from each other and then exert a respective spring force F in the transverse direction Qr on the tab contact section 550 (FIG. 5).

The cover wall 230 has at least one mechanical contact spring 232 attached in the longitudinal direction Lr to one side (as in the present case) or both sides of the receptacle body 200. A relevant attachment 233 to the receptacle body 200 is here an integral one. If the cover contact spring 232 is attached on one side as illustrated, the attachment 223 is preferably an approximately 180° attachment 233, and in the case of an approximately 0° attachment 233, the cover contact spring 232 is exposed from the cover wall 230, for example in the manner of a strip.

A cover contact spring 232 illustrated (cf in particular FIG. 3) merges integrally into the cover wall 230 via an approximately 180° attachment 233. Starting from the approximately 180° attachment 233, the cover contact spring 232 comprises a (front) spring section 234 which protrudes into the tab contact receptacle 250 and ends in a mechanical contact projection 235 protruding furthest from the cover contact spring 232 into the tab contact receptacle 250.

Starting from the contact projection 235, the cover contact spring 232 retreats again in the direction of its cover wall 230 via a (rear) spring section 236 and ends there in a free end section 237. The free end section 237 comprises, situated opposite the inner side of the cover wall 230, a curvature and bears with the latter in sliding fashion against the cover wall 230. In the case of a cover contact spring 232 attached on both sides, it here merges of course into the cover wall 230.

In particular, the cover wall 230 has a plurality or multiplicity of such cover contact springs 232 by means of which the tab contact section 550 can be pushed or pressed onto the contacting regions 112. The free end sections 237 of the cover contact springs 232 can here be spaced apart from each other in the transverse direction Qr or be connected to each other integrally.

In embodiments, the contact springs 222, 232 can be formed as congruent and/or substantially the same (FIG. 3). It is of course possible to form the contact springs 222, 232 differently, it being preferred that the contact springs 222 of the side walls 220 and/or the contact springs 232 of the cover walls 230 are formed in each case as substantially the same.

The bottom wall 210 of the contact spring cage 20 protrudes in the longitudinal direction Lr, preferably on both sides, from underneath the plug contact section 110 (an exception here are the mounting tabs 214), cf FIGS. 2 and 4, and is preferably aligned in the transverse direction Qr with the connection piece 10, cf FIGS. 4 and 5. The same applies for those regions of the side walls 220 which adjoin the bottom wall 210.

Viewed in the transverse direction Qr, a contact projection 225, 235 can of course be configured in the flat socket terminal 1, displaced upward in the vertical direction Hr, between two contacting regions 112 directly adjacent to each other in the longitudinal direction Lr, cf FIG. 3. Viewed in the longitudinal direction Lr, a mounting tab 214 can of course be configured in the flat socket terminal 1, offset in the longitudinal direction Lr, between two contacting regions 112 directly adjacent to each other in the transverse direction Qr, cf FIG. 1.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Vibration-resistant electromechanical flat socket terminal for an electrical connection comprising:
an essentially cuboid tab contact receptacle into which an essentially cuboid tab contact section of an electrical mating terminal for making electrical contact with the flat socket terminal can be plugged, wherein the tab contact receptacle is formed between a plug contact section of an electromechanical connection piece and a mechanical contact spring cage, formed apart therefrom, of the flat socket terminal.

2. Flat socket terminal according to claim 1, wherein:
the single flat socket terminal is formed as a terminal which is rigidly mechanically connected in at least or exactly two parts from the plug contact section and the contact spring cage,
the contact spring cage is built on the plug contact section with a substantially flat form, and an upper inner side of the contact spring cage and an outer side of the plug contact section delimit the tab contact receptacle, and/or
at least one further lateral inner side of the contact spring cage delimit the tab contact receptacle.

3. Flat socket terminal according to claim 1, wherein:
the plug contact section of the connection piece is formed as a tab,
at least the plug contact section of the connection piece is formed as a materially bonded single piece or integrally, and/or
the plug contact section has a plurality of electromechanical contacting regions at/in the tab contact receptacle.

4. Flat socket terminal according to claim 3, wherein the contact spring cage:
is accessible for the tab contact section at at least or exactly one side,
is formed as a single piece, as a materially bonded single piece or integrally, and/or
is formed as a bent spring and/or a stamped spring.

5. Flat socket terminal according to claim 1, wherein:
the contact spring cage is formed as substantially closed at at least three, at least four or at five sides,
a cover wall of the contact spring cage has at least one mechanical cover contact spring protruding or projecting into the tab contact receptacle,
at least one side wall of the contact spring cage has a mechanical side contact spring protruding or projecting into the tab contact receptacle, and/or
the at least one cover contact spring and/or the at least one side contact spring is formed as a contact spring bent by approximately 180° into the tab contact receptacle.

6. Flat socket terminal according to claim 1, wherein the contact spring cage is formed in such a way that:
the contact springs center the tab contact section plugged into the tab contact receptacle there and push the tab contact section against the plug contact section,
a spring direction of the at least one cover contact spring and a spring direction of the at least one side contact spring are substantially perpendicular to each other,
the at least one cover contact spring and the at least one side contact spring extend substantially in a longitudinal direction of the flat socket terminal, and/or
a cover contact spring and/or a side contact spring has exactly or at least one mechanical contact projection for making electromechanical contact with the tab contact section.

7. Flat socket terminal according to claim 1, wherein at/in the tab contact receptacle:
the at least one cover contact spring is configured to be spring-loaded in a vertical direction of the flat socket terminal above the plug contact section,
the at least one side contact spring is configured to be spring-loaded in a transverse direction of the flat socket terminal above the plug contact section, and/or
two side contact springs situated opposite each other in the transverse direction are configured to be spring-loaded against each other.

8. Flat socket terminal according to claim 1, wherein:
the contact spring cage has a bottom wall via which the contact spring cage is fixed to the plug contact section,
the two side walls each have a through opening through which the plug contact section is plugged into the contact spring cage, and/or
the plug contact section is fixed in the receptacle body on the bottom wall by a mounting means.

9. Flat socket terminal according to claim 1, wherein:
a through opening, on an inside of the socket terminal, of the side wall is dimensioned in such a way that substantially the whole plug contact section can be plugged through in a transverse direction,
the through opening on the inside of the socket terminal is dimensioned in such a way that at least one blocking shoulder of the connection piece sits on an outside of the receptacle body, and/or
a through opening, on an outside of the socket terminal, of the side wall is dimensioned in such a way that at least one blocking shoulder of the plug contact section sits on an inside of the receptacle body.

10. Flat socket terminal according to claim 1, wherein:
a mounting means is formed as a mounting tab of the bottom wall which is exposed from the bottom wall,
the mounting tab engages around an edge of the plug contact section and fixes the receptacle body on the plug contact section, and/or
a free end section of the mounting tab is bent at/in the tab contact receptacle into a recess of the plug contact section.

11. Vibration-resistant electrical connector for a vehicle comprising:
a connector housing; and
an electromechanical flat socket terminal configured thereon/therein, the flat socket terminal including an essentially cuboid tab contact receptacle into which an essentially cuboid tab contact section of an electrical mating terminal for making electrical contact with the flat socket terminal can be plugged, wherein the tab contact receptacle is formed between a plug contact section of an electromechanical connection piece and a mechanical contact spring cage, formed apart therefrom, of the flat socket terminal.

12. Vibration-resistant electrical connector according to claim 11, wherein:
the single flat socket terminal is formed as a terminal which is rigidly mechanically connected in at least or exactly two parts from the plug contact section and the contact spring cage,
the contact spring cage is built on the plug contact section with a substantially flat form, and an upper inner side of the contact spring cage and an outer side of the plug contact section delimit the tab contact receptacle, and/or
at least one further lateral inner side of the contact spring cage delimit the tab contact receptacle.

13. Vibration-resistant electrical connector according to claim 11, wherein:
the plug contact section of the connection piece is formed as a tab,
at least the plug contact section of the connection piece is formed as a materially bonded single piece or integrally, and/or
the plug contact section has a plurality of electromechanical contacting regions at/in the tab contact receptacle.

14. Vibration-resistant electrical connector according to claim 13, wherein the contact spring cage:
is accessible for the tab contact section at at least or exactly one side,
is formed as a single piece, as a materially bonded single piece or integrally, and/or
is formed as a bent spring and/or a stamped spring.

15. Vibration-resistant electrical connector according to claim 11, wherein:
the contact spring cage is formed as substantially closed at at least three, at least four or at five sides,
a cover wall of the contact spring cage has at least one mechanical cover contact spring protruding or projecting into the tab contact receptacle,
at least one side wall of the contact spring cage has a mechanical side contact spring protruding or projecting into the tab contact receptacle, and/or
the at least one cover contact spring and/or the at least one side contact spring is formed as a contact spring bent by approximately 180° into the tab contact receptacle.

16. Vibration-resistant electrical connector according to claim 11, wherein the contact spring cage is formed in such a way that:
the contact springs center the tab contact section plugged into the tab contact receptacle there and push the tab contact section against the plug contact section,
a spring direction of the at least one cover contact spring and a spring direction of the at least one side contact spring are substantially perpendicular to each other,
the at least one cover contact spring and the at least one side contact spring extend substantially in a longitudinal direction of the flat socket terminal, and/or
a cover contact spring and/or a side contact spring has exactly or at least one mechanical contact projection for making electromechanical contact with the tab contact section.

17. Vibration-resistant electrical connector according to claim 11, wherein at/in the tab contact receptacle:
the at least one cover contact spring is configured to be spring-loaded in a vertical direction of the flat socket terminal above the plug contact section,
the at least one side contact spring is configured to be spring-loaded in a transverse direction of the flat socket terminal above the plug contact section, and/or
two side contact springs situated opposite each other in the transverse direction are configured to be spring-loaded against each other.

18. Vibration-resistant electrical connector according to claim 11, wherein:
the contact spring cage has a bottom wall via which the contact spring cage is fixed to the plug contact section,
the two side walls each have a through opening through which the plug contact section is plugged into the contact spring cage, and/or
the plug contact section is fixed in the receptacle body on the bottom wall by a mounting means.

19. Vibration-resistant electrical connection for a vehicle comprising:
an electromechanical flat socket terminal including an essentially cuboid tab contact receptacle, the tab contact receptacle formed between a plug contact section of an electromechanical connection piece and a mechanical contact spring cage, formed apart therefrom, of the flat socket terminal; and
an electrical mating terminal having an essentially cuboid tab contact section plugged into the tab contact receptacle for making electrical contact with the flat socket terminal, wherein the tab contact section is formed so that it partially complements the tab contact receptacle of the flat socket terminal.

20. Electrical connection according to claim 19, wherein:
the tab contact section has at least one partially complementary clamping means, corresponding to the contact spring cage,
a mechanical contact region of a contact spring of the contact spring cage is seated in the clamping means, and/or
at least one blocking projection of the tab contact section sits on an outer edge of an opening of the tab contact receptacle.

21. Electrical connection according to claim 19, wherein a mechanical contact region of a contact spring and a clamping means of the tab contact section are mutually designed in such a way that, in case of vibrations on the connection, the tab contact section has the tendency to move further into the tab contact receptacle.
